(19) United States
(12) Patent Application Publication
(10) Pub. No.: US 2025/0020398 A1
(43) Pub. Date: Jan. 16, 2025

(54) SHIP BOIL-OFF GAS RELIQUEFACTION SYSTEM AND METHOD

(71) Applicant: HANWHA OCEAN CO., LTD., Geoje-si, Gyeongsangnam-do (KR)

(72) Inventors: Zie Hyun Kim, Yongin-si, Gyeonggi-do (KR); Won Jae Choi, Siheung-si, Gyeonggi-do (KR); Sung Kak Lyu, Gunpo-si, Gyeonggi-do (KR)

(21) Appl. No.: 18/712,080

(22) PCT Filed: Dec. 27, 2021
(86) PCT No.: PCT/KR2021/019908

§ 371 Date: May 21, 2024

(30) Foreign Application Priority Data
Nov. 23, 2021 (KR) 10-2021-0162298

(51) Int. Cl. F25J 1/02

(52) U.S. Cl. CPC F25J 1/0255; F25J 2290/72

(57) ABSTRACT

Disclosed are a ship boil-off gas reliquefaction system and method. The boil-off gas reliquefaction system includes: a storage tank disposed in a ship and storing a liquefied gas; a compressor compressing boil-off gas generated from the liquefied gas; a reliquefaction apparatus reliquefying the compressed gas compressed in the compressor by cooling the compressed gas through heat exchange with a refrigerant circulating in a refrigerant circulation part; and a reliquefaction capacity controller controlling reliquefaction capacity of the reliquefaction apparatus, wherein, when a pressure value sensed at a vapor header through which the boil-off gas is discharged from the storage tank is lower than a preset low pressure value, the reliquefaction capacity controller reduces the reliquefaction capacity of the reliquefaction apparatus to maintain a pressure in the storage tank.

### TECHNICAL FIELD

The present invention relates to a boil-off gas reliquefaction system and method in which boil-off gas (BOG) generated from a liquefied gas stored in a storage tank of a ship is cooled and reliquefied, while allowing a pressure in the storage tank to be kept constant by adjusting reliquefaction capacity of a reliquefaction apparatus according to the pressure in the storage tank.

### BACKGROUND ART

Natural gas contains methane as a main component and has been attracting attention as an eco-friendly fuel that emits little or no environmental pollutants during combustion. Liquefied natural gas (LNG) is obtained by liquefying natural gas through cooling to about −163° C. under normal pressure and is suited to long-distance transportation by sea since it has a volume of about 1/600 that of natural gas in a gaseous state. Accordingly, natural gas is stored and transported as liquefied natural gas, which is easy to store and transport.

Since natural gas is liquefied at a cryogenic temperature of −163° C. under normal pressure, LNG storage tanks are typically insulated to maintain LNG in a liquid state. However, despite being insulated, such a storage tank is limited in ability to block external heat. Accordingly, due to external heat continuously transferred to the LNG storage tank, LNG stored in the LNG tank continues to evaporate naturally during transportation, causing generation of boil-off gas (BOG).

Continuous production of boil-off gas in the LNG storage tank increases the internal pressure of the LNG storage tank. If the internal pressure of the storage tank exceeds a predetermined safe pressure, this can cause emergency situations such as rupture of the storage tank. Accordingly, there is a need to discharge boil-off gas from the storage tank using a safety valve. However, boil-off gas is a kind of LNG loss and is an important issue for transportation efficiency and fuel efficiency of LNG. Therefore, various methods are employed to handle boil-off gas generated in the LNG storage tank.

Recently, a method of using boil-off gas at a fuel demand site such as an engine of a ship, a method of reliquefying boil-off gas and returning the reliquefied boil-off gas to an LNG storage tank, and a method combining these two approaches have been developed and put into use.

### DISCLOSURE

### Technical Tasks

In a reliquefaction cycle for reliquefaction of boil-off gas generated in a ship, typical available liquefaction methods include a process using a single mixed refrigerant (SMR) cycle and a process using a propane-precooled mixed refrigerant (C3MR) cycle. The C3MR cycle is a process in which natural gas is cooled using propane refrigerant alone and then is liquefied and subcooled using a mixed refrigerant, while the SMR cycle is a process in which natural gas is liquefied using a mixed refrigerant composed of multiple components.

As such, the SMR cycle and the C3MR cycle both use a mixed refrigerant. However, if the composition of the mixed refrigerant changes due to refrigerant loss during liquefaction of boil-off gas, this can lead to poor liquefaction efficiency. Accordingly, there is a need to maintain constant composition of the refrigerant by continuously measuring the composition of the mixed refrigerant and replenishing lacking refrigerant components.

An alternative reliquefaction cycle to reliquefy boil-off gas is a single-cycle liquefaction process using nitrogen refrigerant.

Despite relative inefficiency compared to a reliquefaction cycle using a mixed refrigerant, such a reliquefaction cycle using nitrogen refrigerant is safer due to inert properties of nitrogen refrigerant and is easier to apply to ships since nitrogen refrigerant does not undergo phase change.

Boil-off gas generated during operation of a ship may be discharged from a storage tank, compressed by a compressor, and supplied as fuel or introduced into a reliquefaction cycle to be reliquefied and returned to the storage tank. Regulation of reliquefaction capacity of the reliquefaction system may be carried out by adjusting the amount of cold heat in the reliquefaction cycle through a controller.

However, if the reliquefaction system continues to reliquefy a greater amount of boil-off gas than the amount of boil-off gas generated in the storage tank, or if the reliquefied gas having passed through the reliquefaction system, such as a reliquefaction cycle adopting nitrogen as a refrigerant, is introduced into the storage tank in a subcooled state to maintain reliquefaction capacity of the reliquefaction system despite reduction in amount of boil-off gas generated in the storage tank, the internal pressure of the storage tank can drop excessively, causing a dangerous situation, such as tank failure.

To solve this problem, the present invention proposes a reliquefaction system and method to maintain the pressure of the storage tank stably by operating the reliquefaction system based on the pressure of the storage tank.

### Technical Solution

In accordance with one aspect of the present invention, there is provided a boil-off gas reliquefaction system for ships, including: a storage tank disposed in a ship and storing a liquefied gas;
a compressor compressing boil-off gas generated from the liquefied gas;
a reliquefaction apparatus reliquefying the compressed gas compressed in the compressor by cooling the compressed gas through heat exchange with a refrigerant circulating in a refrigerant circulation part; and
a reliquefaction capacity controller controlling reliquefaction capacity of the reliquefaction apparatus,
wherein, when a pressure value sensed at a vapor header through which the boil-off gas is discharged from the storage tank is lower than a preset low pressure value, the reliquefaction capacity controller reduces the reliquefaction capacity of the reliquefaction apparatus to maintain a pressure in the storage tank.

Preferably, the boil-off gas reliquefaction system further includes: a first pressure transmitter sensing an absolute pressure of the boil-off gas at the vapor header; a second pressure transmitter sensing a gauge pressure of the boil-off gas at the vapor header; a typical pressure control unit receiving a pressure value sensed by the first pressure transmitter and adjusting the reliquefaction capacity of the reliquefaction apparatus to maintain the pressure in the storage tank at a target value; and a low pressure controller controlling the reliquefaction capacity controller to forcibly reduce the reliquefaction capacity of the reliquefaction apparatus when a pressure value sensed by the second pressure transmitter is lower than the preset low pressure value.

Preferably, the typical pressure control unit includes: a first typical pressure controller outputting an operation signal for adjusting the reliquefaction capacity of the reliquefaction apparatus based on the pressure value sensed by the first pressure transmitter; a second typical pressure controller outputting an operation signal for adjusting the reliquefaction capacity of the reliquefaction apparatus based on the pressure value sensed by the second pressure transmitter; and a selector selecting and outputting an operation signal for adjusting the reliquefaction capacity to the reliquefaction capacity controller among the operation signals output from the first and second typical pressure controllers, wherein the typical pressure control unit and the reliquefaction capacity controller are connected in a cascade.

Preferably, the reliquefaction apparatus is provided in plural and each of the reliquefaction apparatuses is installed as an independent train in the ship and is provided with a reliquefaction capacity controller.

Preferably, each of the trains is provided with a train capacity controller controlling the reliquefaction capacity controller of the reliquefaction apparatus disposed on the corresponding train.

Preferably, the reliquefaction apparatus of each train is connected to the typical pressure control unit to be operated thereby, or is operated independently of the typical pressure control unit by the train capacity controller.

In accordance with another aspect of the present invention, there is provided a boil-off gas reliquefaction method for ships, wherein a compressor compresses boil-off gas generated from a liquefied gas stored in a storage tank of a ship,
the compressed gas compressed in the compressor is cooled and reliquefied through heat exchange with a refrigerant circulating in a refrigerant circulation part of a reliquefaction apparatus,
a reliquefaction capacity controller adapted to control reliquefaction capacity of the reliquefaction apparatus is provided to maintain a pressure of the storage tank by reducing the reliquefaction capacity of the reliquefaction apparatus when a pressure value sensed at a vapor header through which the boil-off gas is discharged from the storage tank is lower than a preset low pressure value.

Preferably, a first pressure transmitter senses an absolute pressure of the boil-off gas, a typical pressure control unit adjusts the reliquefaction capacity of the reliquefaction apparatus based on a pressure value sensed by the first pressure transmitter to maintain the pressure of the storage tank at a target value, a second pressure transmitter senses a gauge pressure of the boil-off gas at the vapor header, and a low pressure controller controls the reliquefaction apparatus to forcibly reduce the reliquefaction capacity of the reliquefaction apparatus, when a pressure value sensed by the second pressure transmitter is lower than a preset low pressure value.

Preferably, the typical pressure control unit includes: a first typical pressure controller outputting an operation signal for adjusting the reliquefaction capacity of the reliquefaction apparatus based on the pressure value sensed by the first pressure transmitter; a second typical pressure controller outputting an operation signal for adjusting the reliquefaction capacity of the reliquefaction apparatus based on the pressure value sensed by the second pressure transmitter; and a selector selecting and outputting an operation signal for adjusting the reliquefaction capacity to the reliquefaction capacity controller among the operation signals output from the first and second typical pressure controllers, wherein the typical pressure control unit and the reliquefaction capacity controller are connected in a cascade.

Preferably, the reliquefaction apparatus is provided in plural, each of the reliquefaction apparatuses being installed as an independent train in the ship and being provided with a reliquefaction capacity controller, and the reliquefaction apparatus of each train is connected to the typical pressure control unit to be operated thereby, or is operated independently of the typical pressure control unit by a train capacity controller controlling a reliquefaction capacity controller of the reliquefaction apparatus provided to each train.

### Advantageous Effects

The system and method according to the present invention allow a pressure of a storage tank to be kept constant by adjusting reliquefaction capacity of a reliquefaction apparatus according to the pressure of the storage tank.

As such, even when multiple reliquefaction apparatuses using separate refrigerants, such as nitrogen, are provided, the reliquefaction system can efficiently operate and can maintain the pressure of the storage tank by adjusting reliquefaction capacity of the reliquefaction apparatus based on the pressure of the storage tank, thereby preventing tank damage due to excessive increase or decrease in pressure of the storage tank while securing safety of the ship.

### DESCRIPTION OF DRAWINGS

FIG. 1 is a schematic diagram of a boil-off gas reliquefaction system for ships according to one embodiment of the present invention.

FIG. 2 and FIG. 3 are graphs depicting total reliquefaction apparatus load change depending on an output value change according to pressure of boil-off gas sensed at a vapor header in the reliquefaction system according to the embodiment of the present invention, in which three trains of reliquefaction apparatuses are provided.

### EMBODIMENTS

In order to fully appreciate the operational advantages of the present invention and the objectives achieved by practicing the present invention, reference should be made to the accompanying drawings, which illustrate embodiments of the present invention, and description thereof.

Hereinafter, embodiments of the present invention will be described in detail in terms of the features and effects thereof with reference to the accompanying drawings. It should be noted that like components will be denoted by like reference numerals throughout the specification and the accompanying drawings.

As used herein, the term “ship” may refer to any type of ship that is provided with a liquefied gas storage tank. For example, the ship may include self-propelled vessels, such as an LNG carrier, a liquid hydrogen carrier, and an LNG regasification vessel (RV), as well as non-self-propelled floating offshore structures, such as an LNG floating production storage and offloading (FPSO) unit and an LNG floating storage regasification unit (FSRU).

In addition, the embodiments of the present invention may be applied to a reliquefaction cycle for any type of liquefied gas that can be transported in a liquid state by liquefaction at cryogenic temperatures and can generate boil-off gas during storage. For example, such liquefied gas may include liquefied petrochemical gas, such as liquefied natural gas (LNG), liquefied ethane gas (LEG), liquefied petroleum gas (LPG), liquefied ethylene gas, and liquefied propylene gas. In the following embodiments, the present invention will be described using LNG, which is a typical liquefied gas, as an example.

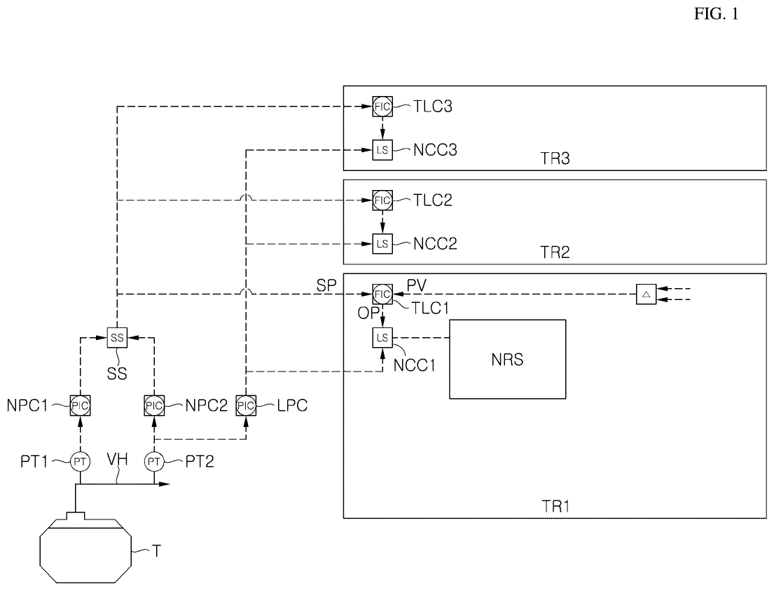

FIG. 1 is a schematic diagram of a boil-off gas reliquefaction system for ships according to one embodiment of the present invention.

Referring to FIG. 1, the reliquefaction system according to this embodiment includes a storage tank T disposed in a ship and storing a liquefied gas, a compressor compressing boil-off gas generated from the liquefied gas, and a reliquefaction apparatus NRS cooling and reliquefying the compressed gas compressed in the compressor through heat exchange with a refrigerant circulating in a refrigerant circulation part.

Boil-off gas generated from the cold liquefied gas stored in the storage tank T is discharged through a vapor header VH and is supplied to the compressor (not shown). The compressor (not shown) compresses the boil-off gas to, for example, a fuel supply pressure required for a main engine of the ship. For example, the compressor may compress the boil-off gas to a pressure of 5.5 barg for a DF engine, 15 barg for an X-DF engine, and 300 barg for an ME-GI engine. The compressed boil-off gas may be supplied as fuel to the main engine (not shown) of the ship and surplus compressed boil-off gas may be reliquefied.

Classification societies require that the compressor supplying fuel to an engine be designed with redundancy in case of emergency. Accordingly, although one compressor is shown in FIG. 1, the compressor may include a main compressor and a redundant compressor.

The compressed gas compressed in the compressor and not used as fuel is supplied to a reliquefaction apparatus to be reliquefied.

The reliquefaction apparatus NRS includes a heat exchanger cooling the compressed gas compressed in the compressor through heat exchange, and a gas-liquid separator disposed downstream of the heat exchanger and separating the reliquefied gas into a gaseous phase and a liquid phase. As needed, a decompression valve may be further disposed upstream of the gas-liquid separator in a reliquefaction line to depressurize the compressed gas cooled in the heat exchanger and to adjust the reliquefaction amount.

The heat exchanger cools and re-liquefies the compressed gas using a refrigerant circulating in the refrigerant circulation part as a source of cold heat. The boil-off gas discharged from the storage tank also passes through the heat exchanger and is introduced into the compressor after recovery of cold heat in the heat exchanger, whereby cold heat of uncompressed boil-off gas can also be used in the heat exchanger.

The reliquefied gas cooled in the heat exchanger and then separated in the gas-liquid separator may be supplied to the storage tank to be stored again and flash gas may be supplied to a stream of uncompressed boil-off gas upstream of the heat exchanger in a boil-off gas supply line or may be delivered to a GCU.

In the refrigerant circulation part (not shown) of the reliquefaction apparatus NRS, the refrigerant circulates along the refrigerant circulation line and cools the compressed gas through heat exchange in the heat exchanger. The refrigerant circulating in the refrigerant circulation line may be, for example, nitrogen.

The refrigerant circulation part includes a refrigerant expander in which a refrigerant to be supplied to the heat exchanger is expanded and cooled, and a refrigerant compressor connected to the refrigerant expander to receive expansion energy of the refrigerant and to compress the refrigerant discharged from the heat exchanger after heat exchange in the heat exchanger. A motor is provided to drive the refrigerant compressor and the refrigerant compressor and the refrigerant expander may be coaxially connected to each other to compress the refrigerant using the expansion energy of the refrigerant, thereby reducing power for driving the refrigerant cycle.

The refrigerant that has been expanded and cooled in the refrigerant expander is introduced into the heat exchanger to supply cold heat, and the refrigerant discharged from the heat exchanger after heat exchange in the heat exchanger is compressed in the refrigerant compressor. The refrigerant compressed in the refrigerant compressor is cooled through the heat exchanger and supplied to the refrigerant expander to be expanded and cooled, and is then supplied again to the heat exchanger, thereby circulating along the refrigerant circulation line.

Accordingly, in the heat exchanger, four streams of boil-off gas compressed in the compressor, uncompressed boil-off gas to be introduced into the compressor, the refrigerant expanded and cooled in the refrigerant expander, and the refrigerant compressed in the refrigerant compressor undergo heat exchange, in which the compressed gas compressed in the compressor and the refrigerant compressed in the compressor are cooled through heat exchange with the uncompressed boil-off gas to be introduced into the compressor and the refrigerant expanded and cooled in the refrigerant expander.

The reliquefaction apparatus NRS is provided with reliquefaction capacity controllers NCC1, NCC2, NCC3 that control reliquefaction capacity thereof.

The reliquefaction apparatus may be provided in plural in a ship, and when multiple reliquefaction apparatuses are provided, each of the reliquefaction apparatuses is installed as an independent train in the ship and multiple reliquefaction apparatus trains TR1, TR2, TR3 are provided with reliquefaction capacity controllers NCC1, NCC2, NCC3, respectively. In addition, each train including the reliquefaction apparatus may be provided with a train capacity controller TLC1, TLC2 or TLC3 that controls the reliquefaction capacity controller of the reliquefaction apparatus installed on the corresponding train.

According to the present invention, the reliquefaction capacity of the reliquefaction apparatus may be adjusted based on the pressure in the storage tank.

To this end, the reliquefaction system includes a first pressure transmitter PT1 sensing an absolute pressure of boil-off gas at a vapor header VH and a second pressure transmitter PT2 sensing a gauge pressure of the boil-off gas at the vapor header.

The reliquefaction system includes a typical pressure control unit that adjusts reliquefaction capacity of the reliquefaction apparatus based on pressure values sensed by the first and second pressure transmitters to maintain the pressure of the storage tank at a target value within a certain range.

The reliquefaction system further includes a low-pressure controller LPC that can forcibly reduce the reliquefaction capacity of the reliquefaction apparatus, particularly to prevent excessive reduction in pressure of the storage tank.

When the pressure at the vapor header sensed by the second pressure transmitter PT2 is lower than a preset low pressure value, the low pressure controller LPC may control the reliquefaction capacity controllers NCC1, NCC2, NCC3 to forcibly reduce the reliquefaction capacity of the reliquefaction apparatus so as to prevent the pressure in the storage tank from dropping excessively, thereby preventing tank breakage.

The typical pressure control unit includes a first typical pressure controller NPC1 that outputs an operation signal for adjusting the reliquefaction capacity of the reliquefaction apparatus based on the pressure sensed by the first pressure transmitter; and a second typical pressure controller NPC2 that outputs an operation signal for adjusting the reliquefaction capacity of the reliquefaction apparatus based on the pressure sensed by the second pressure transmitter, a selector (SS) that selects and outputs an operation signal for adjusting the reliquefaction capacity to the reliquefaction capacity controller NCC1, NCC2 or NCC3 of each train among the operation signals output from the first and second typical pressure controllers. The typical pressure control unit and the reliquefaction capacity controllers may be connected in a cascade to maintain the pressure in the storage tank at a preset target value by automatically adjusting reliquefaction capacity of each of the reliquefaction apparatuses.

When a plurality of reliquefaction apparatus trains TR1, TR2, TR3 is provided, the reliquefaction apparatus of each train may be independently connected to the typical pressure control unit to be operated thereby, or may be operated independently of the typical pressure control unit by the train capacity controllers TLC1, TLC2, TLC3.

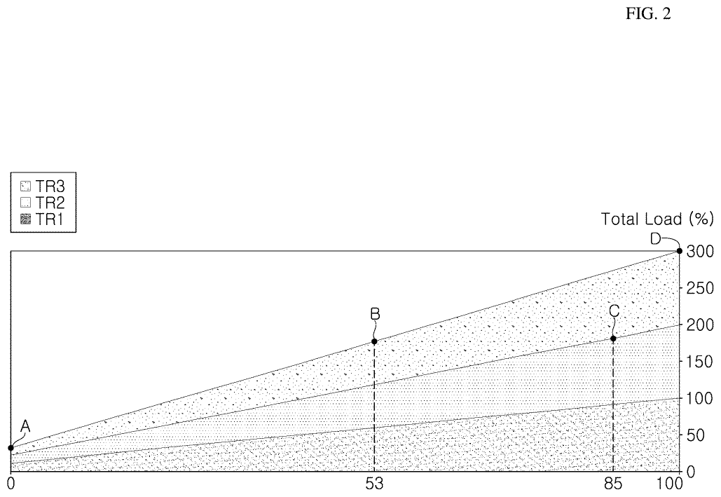

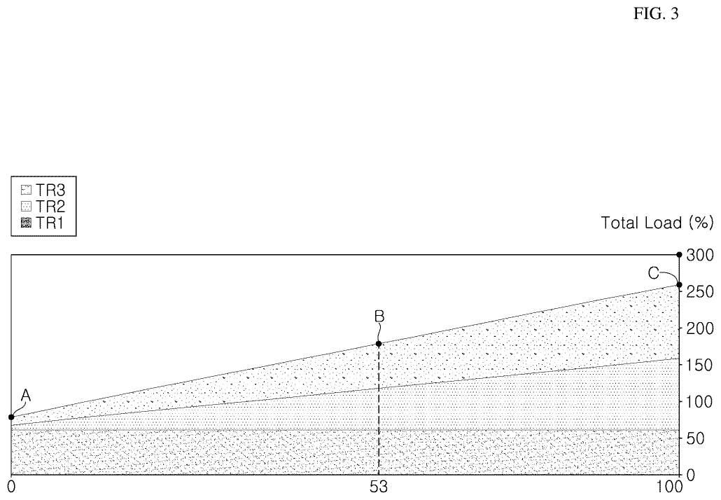

FIG. 2 and FIG. 3 are graphs depicting total reliquefaction apparatus load change depending on an output value change according to pressure of boil-off gas sensed at a vapor header in the reliquefaction system, which is provided with three trains of reliquefaction apparatuses.

First, FIG. 2 is a graph depicting the total reliquefaction apparatus load change depending on the output value change when three trains of the reliquefaction apparatuses are connected to the typical pressure control unit and the reliquefaction capacity controller of each train shares the reliquefaction load based on the output value of the typical pressure control unit according to the pressure of the storage tank.

In the graph, point A corresponds to an output of 0% from the typical pressure control unit, in which the reliquefaction apparatus load of each train is about 11% and the total reliquefaction apparatus load of the three trains has a minimum value of 33%. Point B corresponds to an output of 53%, in which the reliquefaction apparatus load of each train is about 58% and the total reliquefaction apparatus load of the three trains is 173%. Point C corresponds to an output of 85%, where two trains are operated. Here, each of the two trains has a load of 87%, and the total reliquefaction apparatus load is 180%. Point D corresponds to an output of 100%, where each train also has a reliquefaction apparatus load of 100%. Here, the total reliquefaction apparatus load of the three trains has a maximum value of 300%.

Next, FIG. 3 is a graph depicting the total reliquefaction apparatus load change depending on the output value change when one train is operated by the train capacity controller and two trains are connected to the typical pressure control unit to share a reliquefaction load according to an output value thereof.

The first train is operated by the train capacity controller at a fixed reliquefaction load of 58%, and the second and third trains are connected to the typical pressure control unit to share the reliquefaction load according to the output value of the typical pressure control unit based on the pressure of boil-off gas in the storage tank.

At point A, since the first train has a reliquefaction load of 58% and the second and third trains have a typical pressure control unit output of 0%, the reliquefaction apparatuses operates at a minimum load of about 11% and the total reliquefaction apparatus load is about 80%. At point B, since the first train has a reliquefaction load of 58% and the second and third trains have a typical pressure control unit output of 53%, each train operates at a load of 58% and the total reliquefaction apparatus load is 173%. At point C, the first train has a reliquefaction load of 58% and the second and third trains have a maximum typical pressure control unit output of 100% and also operate at a load of 100%. Here, the total reliquefaction apparatus load is 258%.

As such, a plurality of reliquefaction apparatus trains may be operated according to an output value of the typical pressure control unit by connecting the reliquefaction apparatus of each train to the typical pressure control unit, as needed, or may be independently operated by the train capacity controller provided to each train to adjust the reliquefaction apparatus load.

Although some embodiments have been described herein, it will be apparent to a person having ordinary knowledge in the art that the present invention is not limited thereto and may be implemented through various modifications or variations without departing from the technical spirit of the present invention.

1. A boil-off gas reliquefaction system for ships, comprising:
a storage tank disposed in a ship and storing a liquefied gas;
a compressor compressing boil-off gas generated from the liquefied gas;
a reliquefaction apparatus reliquefying the compressed gas compressed in the compressor by cooling the compressed gas through heat exchange with a refrigerant circulating in a refrigerant circulation part; and
a reliquefaction capacity controller controlling reliquefaction capacity of the reliquefaction apparatus,
wherein, when a pressure value sensed at a vapor header through which the boil-off gas is discharged from the storage tank is lower than a preset low pressure value, the reliquefaction capacity controller reduces the reliquefaction capacity of the reliquefaction apparatus to maintain a pressure in the storage tank.

2. The boil-off gas reliquefaction system according to claim 1, further comprising:
a first pressure transmitter sensing an absolute pressure of the boil-off gas at the vapor header;
a second pressure transmitter sensing a gauge pressure of the boil-off gas at the vapor header;
a typical pressure control unit receiving a pressure value sensed by the first pressure transmitter and adjusting the reliquefaction capacity of the reliquefaction apparatus to maintain the pressure in the storage tank at a target value; and
a low pressure controller controlling the reliquefaction capacity controller to forcibly reduce the reliquefaction capacity of the reliquefaction apparatus when a pressure value sensed by the second pressure transmitter is lower than the preset low pressure value.

3. The boil-off gas reliquefaction system according to claim 2, wherein the typical pressure control unit comprises:
a first typical pressure controller outputting an operation signal for adjusting the reliquefaction capacity of the reliquefaction apparatus based on the pressure value sensed by the first pressure transmitter;
a second typical pressure controller outputting an operation signal for adjusting the reliquefaction capacity of the reliquefaction apparatus based on the pressure value sensed by the second pressure transmitter; and
a selector selecting and outputting an operation signal for adjusting the reliquefaction capacity to the reliquefaction capacity controller among the operation signals output from the first and second typical pressure controllers, and
wherein the typical pressure control unit and the reliquefaction capacity controller are connected in a cascade.

4. The boil-off gas reliquefaction system according to claim 3, wherein the reliquefaction apparatus is provided in plural, each of the reliquefaction apparatuses being installed as an independent train in the ship and each being provided with a reliquefaction capacity controller.

5. The boil-off gas reliquefaction system according to claim 4, wherein each of the trains is provided with a train capacity controller controlling the reliquefaction capacity controller of the reliquefaction apparatus disposed on the corresponding train.

6. The boil-off gas reliquefaction system according to claim 5, wherein the reliquefaction apparatus of each train is connected to the typical pressure control unit to be operated thereby, or can be operated independently of the typical pressure control unit by the train capacity controller.

7. A boil-off gas reliquefaction method for ships,
wherein a compressor compresses boil-off gas generated from a liquefied gas stored in a storage tank of a ship,
a compressed gas compressed in the compressor is cooled and reliquefied through heat exchange with a refrigerant circulating in a refrigerant circulation part of a reliquefaction apparatus, and
a reliquefaction capacity controller adapted to control reliquefaction capacity of the reliquefaction apparatus is provided to maintain a pressure of the storage tank by reducing the reliquefaction capacity of the reliquefaction apparatus when a pressure value sensed at a vapor header through which the boil-off gas is discharged from the storage tank is lower than a preset low pressure value.

8. The boil-off gas reliquefaction method according to claim 7, wherein:
a first pressure transmitter senses an absolute pressure of the boil-off gas at the vapor header,
a typical pressure control unit adjusts the reliquefaction capacity of the reliquefaction apparatus based on a pressure value sensed by the first pressure transmitter to maintain the pressure of the storage tank at a target value,
a second pressure transmitter senses a gauge pressure of the boil-off gas at the vapor header, and
a low pressure controller controls the reliquefaction apparatus to forcibly reduce the reliquefaction capacity of the reliquefaction apparatus, when a pressure value sensed by the second pressure transmitter is lower than a preset low pressure value.

9. The boil-off gas reliquefaction method according to claim 8, wherein the typical pressure control unit comprises:
a first typical pressure controller outputting an operation signal for adjusting the reliquefaction capacity of the reliquefaction apparatus based on the pressure value sensed by the first pressure transmitter;
a second typical pressure controller outputting an operation signal for adjusting the reliquefaction capacity of the reliquefaction apparatus based on the pressure value sensed by the second pressure transmitter; and
a selector selecting and outputting an operation signal for adjusting the reliquefaction capacity to the reliquefaction capacity controller among the operation signals output from the first and second typical pressure controllers, and
wherein the typical pressure control unit and the reliquefaction capacity controller are connected in a cascade.

10. The boil-off gas reliquefaction method according to claim 9, wherein the reliquefaction apparatus is provided in plural, each reliquefaction apparatus being installed as an independent train in the ship and being provided with a reliquefaction capacity controller, and
the reliquefaction apparatus of each train is connected to the typical pressure control unit to be operated thereby, or is operated independently of the typical pressure control unit by a train capacity controller controlling a reliquefaction capacity controller of the reliquefaction apparatus provided to each train.
